(19) United States
(12) Patent Application Publication
(10) Pub. No.: US 2009/0239289 A1
(43) Pub. Date: Sep. 24, 2009

(54) Drain Foam Composition and Method of Using the Same

(76) Inventors: Reid M. Ipser, Ponchatoula, LA (US); Neil Richard Tilyou, Hammond, LA (US)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 12/051,036

(22) Filed: Mar. 19, 2008

(51) Int. Cl. C11D 3/00

(52) U.S. Cl. 435/264

(57) ABSTRACT

A foamable aqueous cleaning composition for treating surfaces to dissolve grease and organic waste materials thereon. The foamable aqueous cleaning composition comprises a) about 40 to about 60 percent by weight water; b) about 40 to about 60 percent by weight of a bioremediation agent capable of breaking down organic contaminating material and capable of producing a desired number of colony forming units of microbes; c) optionally, an insect growth regulator; and d) about 7 to about 15 percent by weight of a compatible propellant. The foamable composition is aerosolized to release the foam composition and contacted with the surfaces to be treated. The foamable composition can be used to treat drains, baseboards, cracks, crevices and other similar surfaces, especially in food preparation areas.

### FIELD OF THE INVENTION

The present invention relates generally to an aqueous foamable cleaning composition that is capable of breaking down grease and organic waste materials in food preparation and other areas.

### BACKGROUND OF THE INVENTION

Restaurants, bars, and other food preparation facilities often experience sanitation problems associated with the buildup of kitchen grease and other organic waste on floors, in drains, along baseboards and under heavy equipment. These problems include fruit and drain fly infestations, cockroach infestations, slippery floor surfaces, foul odors and clogged, slow drains. Mopping or hosing/power washing with standard floor or drain cleaning products does not remove grease and organic waste, it simply breaks it up, pushing it into drains and under equipment where it can build up over time.

Bioremediation, which involves the use of selected bacteria to devour toxic waste, has been used for many years as a solution to dealing with industrial waste, and typically involves three steps:

(1) isolating microbes that can digest particular, selected contaminants;

(2) enhancing the “eating” response of these microbes in a laboratory setting; and

(3) letting loose these microbes in a contaminated area to digest pollution that is present.

These naturally occurring bacteria thrive and grow while the contaminant is abundant. Once the food source (i.e., contaminant) is depleted, the bacteria die and the environment returns to its original state.

The use of bioremediation to break down animal fats and food products that tend to accumulate in drains and pipes of restaurants, hotels, and other food establishments has been suggested as a means of preventing drains and pipes from clogging and for clearing clogged drains and pipes once they have clogged and various products have been developed in this regard.

U.S. Pat. No. 5,225,083 to Pappas et al., the subject matter of which is herein incorporated by reference in its entirety, describes a method of clearing domestic, commercial and industrial grease traps of animal fat and vegetable oil using a multi-step bioremediation process. The method of the invention includes the steps of (1) mechanically removing solid materials from drain lines connecting the grease traps, (2) adjusting the pH of the liquid in the grease traps by introducing a basic material such as baking soda or bicarbonate of soda into the drain lines and grease traps and mixing the effluent in the grease traps to stimulate endemic native bacteria resident in the grease trap, and (3) adding endemic bacterial microorganisms to one or more of the drain lines for digesting grease in the grease traps. This process requires a number of steps and involves the creation of an environment and ecosystem in the grease trap which is conducive to the biodigestion of grease.

U.S. Pat. No. 5,449,619 to Griffin et al., the subject matter of which is herein incorporated by reference in its entirety, describes a liquid drain opener composition that comprises a suspension of viable microorganisms, a surfactant, and a preservative in an aqueous medium and having a pH in the range of about 3 to 10. Because this composition is a water-based composition, the drain cleaning composition must be left to stand overnight. While the drain can be treated for shorter periods, these “shorter periods” are still in excess of about 3 hours.

BMDT-06 Microbial Drain and Baseboard Treatment, available from Biological Systems, Inc. (Austin, Tex.) is an example of a commercial product that has been designed to consume oil, grease and sugars found in drain lines and grease traps of food establishments. BMDT-06 is made up of a combination of “non-harmful” biodegradable cleansers and laboratory colonized, “non-harmful,” USDA certified microbes. The BMDT product is applied with a pressurized foaming system, such as a Bio-Sys Porta-foaming Applicator, available from Biological System, Inc. (Austin, Tex.) and must first be mixed with water (i.e., one quart BMDT-06 to three quarts of water). Once the microbes are activated, after mixing with water, they will begin to die for lack of food source and/or oxygen in 6-8 hours if not applied or left in the foam dispensing unit, and thus must be used in one application to ensure that the microbes remain active.

Other commercial products designed to be used as drain treatment compositions include for example DF 5000 drain treatment, available from Chemtrec (Kirkland, Wash.) and Invade Bio Drain, available from Rockwell Labs LTD (Minneapolis, Minn.).

It would be desirable to have a microbial-containing composition that is a complete one-component system that can be quickly applied as needed and that does not first need to be mixing with water. In addition, it would also be desirable to have a microbial-containing composition that can be used in multiple applications as needed without losing effectiveness. Finally, it would be desirable to have a microbial containing composition that contains a large number of colony forming units (CFU) of microbes in the composition to enable the product to be applied quickly and effectively.

### SUMMARY OF THE INVENTION

It is an object of the present invention to provide an improved microbial cleaning composition that can clear a clogged drain or other surface within a relatively short period of time.

It is another object of the present invention to provide an improved microbial cleaning composition that can be charged to an aerosol can.

It is still another object of the present invention to provide an improved microbial cleaning composition that can be packaged as a “ready to use” complete system, which does not require additional hardware.

It is still another object of the present invention to provide a packaged “ready to use” aerosol can containing a foamable one-step complete microbial cleaning composition.

It is still another object of the present invention to provide a method of treating a drain or other surface using the unique composition of the invention.

It is still another object of the present invention to provide a foamable one-step microbial cleaning composition that contains a large number of colony forming units (CFU) of microbes in the composition.

It is yet another object of the present invention to minimize the number of preparation steps required to ready a surface or substrate that is to be treated with the microbial cleaning composition.

To that end, the present invention relates generally to a foamable aqueous cleaning composition, the cleaning comprising:
a) about 40 to about 60 percent by weight water;
b) about 40 to about 60 percent by weight of a bioremediation agent capable of breaking down organic contaminating material and capable of producing a desired number of colony forming units of microbes;
c) optionally, an insect growth regulator; and
d) about 7 to about 15 percent by weight of a compatible propellant; and
   wherein the water, and the bioremediation agent, and the insect growth regulator (if used) are charged to an empty can and the aerosol propellant that is compatible with the composition is added to the can.

In another embodiment, the present invention relates generally to a method of treating surfaces to dissolve grease and organic waste materials thereon, wherein the method comprises the steps of:
a) providing a foamable aqueous cleaning composition changed to an aerosol can, the foamable cleaning composition comprising:
   i) about 40 to about 60 percent by weight water;
   ii) about 40 to about 60 percent by weight of a bioremediation agent capable of breaking down organic contaminating material and capable of producing a desired number of colony forming units of microbes;
   iii) optionally, an insect growth regulator; and
   iv) about 7 to about 15 percent by weight of a compatible propellant; and
b) aerosolizing the foamable composition to release the foam composition through a nozzle in the aerosol can
c) contacting the foam composition with the surfaces to be treated, and
d) allowing the foam composition to stand on the surfaces to be treated until the foam dissipates.
wherein grease and organic waste materials on the surfaces to be treated are dissolved and consumed.

### DETAILED DESCRIPTION OF INVENTION

The present invention relates to an improved composition and method of using the composition to treat contaminated surfaces and consume organic waste, including oil, grease and sugars, found in drain lines and grease traps of restaurants and bars in the food services industry, given by way of example and not limitation. The composition of the invention works to remove the breeding areas of pests by eliminating their food sources in drains, baseboards and other areas that have traditionally been very difficult to effectively treat and that serve as hatching areas for pests such as cockroaches and fruit flies.

In one embodiment, the composition of the invention is a unique foamable product that utilizes a bioremediation agent that is capable of producing a desired number of colony forming units per unit of the composition (i.e., a desired number of colony forming units per aerosol can) which may include bioremediation agents having active ingredients that are similar to those contained in BMDT-06, DF-5000 and Invade Bio Drain, by way of example and not limitation. The composition of the invention provides a bacterial formula drain cleaning product that is charged to an aerosol can as a “ready to use” complete system, which does not require any additional hardware. As an aerosol, the application method of the composition of the invention is unique because of the containment of product and stability of volume flow. Efficacy is further facilitated by means of a supplied application tube, whereby the applicator can treat the smallest of drains as well as the smallest of cracks and crevices along baseboards. Furthermore, the propellant system of the invention produces maximum foam expansion, which significantly increases the surface/volume ratio of the bacteria formulation of the invention.

Another unique feature of the composition of the present invention is that the foamable composition of the invention comprises a large number of colony forming units (CFU) of the bacteria per can which allows the product to work more effectively as compared to compositions of the prior art, and thus the composition of the invention is packaged as an aerosol product that contains a higher concentration of spore bacteria as compared to compositions of the prior art. The composition is applied as a foam that is capable of coating baseboards and flowing down the drains where the composition coats the area and helps digest greasy deposits by converting them into safe compounds, including carbon dioxide and water. Stability of the composition is ensured via salt preservatives and the bacteria used, which are in the dormant spore stage.

In one embodiment, the foamable composition of the invention comprises:
a) about 35 to about 60 percent by weight water;
b) about 25 to about 50 percent by weight of a bioremediation agent capable of breaking down organic contaminating material and capable of producing a desired number of colony forming units;
c) optionally, an insect growth regulator; and
d) about 5 to about 20 percent by weight of a compatible propellant; and
wherein the water, the bioremediation agent, and the insect growth regulator (if used) are thoroughly mixed and charged to an empty can and the aerosol propellant that is compatible with the composition is added to the can.

The present invention also relates generally to a method of treating surfaces to dissolve grease and organic waste materials thereon, wherein the method comprises the steps of:
a) providing a foamable aqueous cleaning composition changed to an aerosol can, the foamable cleaning composition comprising:
   i) about 40 to about 60 percent by weight water;
   ii) about 40 to about 60 percent by weight of a bioremediation agent capable of breaking down organic contaminating material and capable of producing a desired number of colony forming units;
   iii) optionally, an insect growth regulator; and
   iv) about 7 to about 15 percent by weight of a compatible propellant;
b) aerosolizing the foamable composition to release the foam composition through a nozzle in the aerosol can;
c) contacting the foam composition with the surfaces to be treated, and
d) allowing the foam composition to stand on the surfaces to be treated until the foam dissipates;
wherein grease and organic waste materials on the surfaces to be treated are dissolved and consumed.

In one embodiment, the composition of the invention comprises approximately equal amounts of water and the bioremediation agent. In a preferred embodiment, the composition of the invention comprises about 45 percent by weigh water, 45 percent by weight of the bioremediation agent and 10 percent by weight of the compatible propellant.

The composition of the invention is formulated to have a near neutral pH so as not to damage drain and baseboard surfaces.

The amount of bioremediation agent present in the composition is dependent in on the viable level of microorganisms present in the composition which can be determined based on the number of colony forming units (CFU) of the microbes in the can. In one embodiment, the composition of the invention comprises at least about 150 billion CFU of microbes per aerosol can, preferably at least about 165 billion CFU of microbes per aerosol can. In another embodiment, the composition of the invention comprises at least about 1.7 trillion CFU of microbes per aerosol can.

Bioremediation agents usable in the composition of the invention typically comprise:
(a) one or more surfactants;
(b) one or more microbes that are capable of digesting organic contaminating material and that are capable of producing the desired CFU of microbes in the aerosol can;
(c) a preservative; and
(d) a balance of water.

Any viable microorganisms, or mixture thereof, capable of surviving the formulation and the intended use environment, and which has the ability to degrade or promote the degradation of lipids, proteins and carbohydrates common to domestic, institutional, and industrial sewage may be used as the microbes in the bioremediation agent of the invention. In one embodiment, the microbes are one or more laboratory-colonized non-harmful USDA certified microbes. The microbes may be present in the bioremediation agent in a weight ratio in the range from about 10% to about 50%, preferably from about 10% to about 30%.

It is generally preferred that the microbes used in the composition of the invention be gram-positive bacteria, including, for example, species of the genus Bacillus such as Bacillus subtilis which are common microbes living in soil

Suitable types of microbes would include strains of Bacillus, Pseudomonas, Arthrobacter, Enterobacter, Citrobacter and Corynebacter. In a preferred embodiment, the genus Bacillus is preferred because it not only has excellent waste degrading abilities but also produces a protected spore form.

The bacteria used may include one or more of the following bacteria: Bacillus licheniformis, Pseudomonas florescens, Alcaligenes latus, Bacillus subtilis, and Pseudomonas putida. In one embodiment, the bacteria include the commercial available bacteria agent BMET-1, which is a bacterial component of the BMTC-2000 product available from Biological Systems, Inc. (Austin, Tex.). The bacterial formulation of BMTC-2000 is certified free of any pathological organisms and has been certified by the USDA for use as a drain cleaner in federally regulated meat and poultry processing plants.

Surfactants usable in the bioremediation agent include for example, ethylenediaminetetraacetic acid (EDTA), Tergitol® NP-9 (alkyl phenol ethoxylate), Calsoft® F-90, Neodol 91-6 (linear alcohol ethoxylate), TC-777 (available from Titan Chemical Corporation, Houston, Tex.), sodium 2-ethylhexyl sulfate, Surfynol 104 (available from Air Products, Inc., Allentown, Pa.), and dodecylbenzene sulfonic acid (DDBSA).

The preservative used in the bioremediation agent may be for example, sodium nitrite or another suitable preservative that is compatible with the composition of the invention.

An insect growth regulator (IGR) may also optionally but preferably be included in compositions of the invention. Insect growth regulators are products or materials that interrupt or inhibit the life cycle of a pest. These products may also act as a chitin synthesis inhibitor, thereby preventing insects from molting. One example of an IGR usable in the compositions of the invention is 2-[1-methyl-2(4-phenoxyphenoxy)ethoxy]pyridine, which is available under the tradename Nylar® (Paragon Professional Pest Control Products, Memphis, Tenn.). This material is photostable (i.e., can be used both outdoors and indoors) and typically has a 3 to 6 month residual indoors and can last about 30 days when used outdoors. Other insect growth regulators, including methoprene and hydroprene, are also usable in the compositions of the invention.

The propellants usable in the foamable composition of the invention typically comprise a hydrocarbon in the form of 1 to 10 carbon atoms. Common propellants include methane, ethane, n-propane, n-butane, isobutane, n-pentane, isopentane, and mixtures thereof. While propellants from the group consisting of fluorocarbons and chlorofluorocarbons can also be used, however environmental concerns relating to the destruction of the earth's ozone layer in its stratosphere have rendered these chemicals undesirable. A preferred propellant for use in the composition of the present invention is A70, which is a mixture of isobutane/propane because it provides sufficient pressure to expel the cleaning composition from the can and it also provides good control over the nature of the spray upon discharge of the aerosol formulation. Furthermore, A70 is also believed to be environmentally safe.

Other propellants that may be used in the composition of the invention include n-butane, isobutane, isobutane/propane mixtures all of which are available from the Phillips Petroleum Company under the respective trademarks A17, A31, A46 and A70, alkyl ethers, such as dimethyl ether, diethyl ether, methyl ethyl ether and diisopropyl ether, halocarbons include dichlorodifluoromethane, dichlorotetrafluoroethane, chlorotrifluoromethane and mixtures thereof, and other non-hydrocarbon propellants such as carbon dioxide, nitrogen, compressed air and the like.

The expansion ratio and propellant system of the composition of the invention provides the user of the product with additional tools to use in unique situations. First, the result of the expansion ratio of the foam composition is to allow greater contact time of the product of the invention with the treated surfaces and also allows the user to treat approximately seven gallons of volume. Furthermore, the user can use a variety of application tubes for hard to reach areas. Thus, regardless of the diameter of the application tube used, the composition of the invention exits the applicator tip and is expandable into uniquely shaped voids. In addition, the applicator is not limited to can placement when applying the product of the invention and can thus be held in any position.

The expansion ratio of the composition of the invention is typically approximately 40 to 1, which is measured by dispensing 20 ml (±2) of the composition to produce the resulting volume of foam in a graduated cylinder. Other expansion ratios, as low as approximately 10 to 1 and as high as approximately 60 to 1 are also usable in the practice of the invention so long as the aerosol can contains an adequate number of CFU of bacteria.

Surfaces that can be treated with the composition of the invention include for example, drains and baseboard crevices and cracks, by way of example and not limitation, including restrooms, janitorial closets, food preparation floor areas, garbage containers and surrounding areas. Some of the only surfaces that cannot be treated with the composition of the invention are food surface preparation areas and areas where the composition may enter the potable water supply.

The contact time of the product with the surface to be treated is approximately 10 to 15 minutes after application for the bacteria to activate. The longer the product is in contact with the surface, the better the efficacy. However, in most applications it has been found that 60 minutes is the maximum amount of time that the foam composition should be in contact with the surface.

When treating drains in hard to reach areas, the composition of the invention can be applied and allowed to sit overnight for maximum efficiency. The bacteria will continue to eat organic matter even after wash through. Organic matter will start to be consumed by the bacteria immediately and after several applications, odors and other associated problems with organic matter will typically disappear.

The composition, including water and active ingredient is charged to an aerosol can and an effective amount of a compatible propellant is added. The composition is used by shaking the can for a sufficient period of time to thoroughly mix the ingredients which is typically about 1-5 seconds. Once the contents have been thoroughly mixed, a void injector tube is attached into the actuator button and the actuator button is depressed to dispense the product. When treating a drain, the product is dispensed until the foam reaches the drain surface. The product is then allowed to stand until the foam dissipates, which takes approximately 10 to 15 minutes. When treating cracks, crevices and baseboards, the product is applied to these surfaces in hard to clean areas and is then wiped off or rinsed into a drain after 10 to 15 minutes. In addition, while the rinsing step may be accomplished to rinse the product away, this step is not necessary in some situation because the product mimics nature and there is no requirement that it is rinsed away. Furthermore, unlike compositions and methods of the prior art, there are also no surface preparation requirements for the surfaces to be treated with the compositions of the invention.

The invention will now be described with reference to the following non-limiting examples:

### EXAMPLE 1

### Determination of CFU/Can of Bioremediation Agent A

The number of colony forming units (CFU) present in a sample of bioremediation agent A was determined by performing an aerobic plate count (APC), which indicates the viable level of microorganisms in the product. The number of CFU of bioremediation agent A present in the sample was determined to be 600,000,000 cfu/ml.

The number of CFU/can of product composition was then determined by determining the fill weight of an aerosol can (about 567 grams) and then using specific gravity to compare the density of the composition to water and convert to milliliters. The specific gravity of the product was determined to be 0.926 g/ml, so the fill weight of the cans was calculated to be about 612 milliliters.

For bioremediation agent A with approximately equal amounts of water and bioremediation agent A, about 274.4 ml of bioremediation agent A and 274.4 ml of water are present in the composition. Thus, the number of CFU in 274.4 ml of bioremediation agent A was determined to be about 165,200,000 CFU, which is the calculated number of CFU of bioremediation agent A per can of the foamable composition of the invention.

### EXAMPLE 2

### Determination of CFU/Can of Bioremediation Agent B

The number of colony forming units (CFU) present in a sample of bioremediation agent B was determined by performing an aerobic plate count (APC), which indicates the viable level of microorganisms in the product. The number of CFU of bioremediation agent B present in the sample was determined to be about 6,170,000,000 cfu/ml.

For bioremediation agent B with approximately equal amounts of water and bioremediation agent A, about 274.4 ml of bioremediation agent A and 274.4 ml of water are used in the composition. Thus, the number of CFU in 274.4 ml of bioremediation agent B was determined to be about 1,700,000,000,000 CFU, which is the calculated number of CFU of bioremediation agent B per can of the foamable composition of the invention.

### COMPARATIVE EXAMPLE 1

### Determination of CFU/Can of Bioremediation Agent C

The number of colony forming units (CFU) present in a sample of bioremediation agent C was determined by performing an aerobic plate count (APC) which indicates the viable level of microorganisms in the product. The number of CFU of bioremediation agent C present in the sample was determined to be about 10,000,000 cfu/ml.

For bioremediation agent C with approximately equal amounts of water and bioremediation agent A, about 274.4 ml of bioremediation agent A and 274.4 ml of water are used in the composition. Thus, the number of CFU in 274.4 ml of bioremediation agent C was determined to be about 2,754,000,000 CFU, which is the calculated number of CFU of bioremediation agent C per can of the foamable composition of the invention, which would not provide an adequate number of CFU per can to obtain the beneficial results of the invention.

### EXAMPLE 3

### Application of Composition to Drains and Pipes

When the composition described herein is applied to a water drain (i.e., restaurant, house, hotel, hospital, etc.) that is coated with organic matter that provides harborage for drain flies the following occurs: Once the product is dispensed the product immediately starts to expand (foam) thereby resulting in an uprising from the P-trap and overflowing from the drain surface. In addition, the product will coat the walls of the drain. As the foam starts to dissolve, a thick sticky liquid is produced that covers the inner piping wall. This process takes up to about 30 to 40 minutes, which allows for complete and significant penetration into thick layers of organic matter, which increases the efficacy of the bacteria. The bacteria immediately start to consume organic matter that is potential harborage for all fly species. The bacteria grow and divide and consumption continues until organic matter is completely consumed.

The composition of the invention will also help expedite other processes. Via the by-process of consumption, the sloughing off of acids and hard oils as water naturally flows through the drain can occur. Although over the counter and professional drain cleaners contain acids might be caustic to the composition of the invention, using the composition of the invention along with these products via a rotational application process will facilitate the removal of clogs, and thus the composition of the invention can also help loosen thicker chucks of material. However, the bacteria in the composition of the invention will not eat food-stuffs and food particles (i.e. carrots, celery, potatoes, etc.).

The composition of the invention may further include the insect growth regulator Nylar®, which also acts as a chitin synthesis inhibitor to prevent insect molting. Molting is a process whereby insects shed their old cuticle layer and grow a new one either due to enlargement or metamorphisms. Nylar® prevents this process via inhibiting specific hormone production paramount to completing this process. As the bacteria eat the organic matter, Nylar® in conjunction with the bioremediation agent also prevents metamorphosis of eggs into larva and larva into pupae in the drain. The overall controlling process is a “double edge sword” whereby multiple pathways are used to prevent and inhibit, prevent, and immediately stop the growth of drain flies and other occasional fly species in drains.

### EXAMPLE 4

### Application of Composition to Baseboards

The use of the composition of the invention results in the removal of organic matter embedded in thick grease build up. After application, the composition is allowed to break down into a liquid and coat the baseboard surface. The breaking down is similar as described above. Depending on the environmental conditions the breaking down process for this application method can take as long as 20-30 minutes, with a minimal time of about 1-2 minutes. After this process, the composition is allowed to sit for an additional 4-6 minutes before wiping off with a damp or dry cloth. A towel or brush can also be used in conjunction with the compositing of the invention to roughen the surface and allow for adequate penetration of the composition of the invention in the “valleys” within the grease surface. However, the composition of the invention can also be used along with a good floor cleaner to expedite removal of grease build up. For full removal of grease build up, a two-week process may be used. As above, an insect growth inhibitor such as Nylar® can also be added and will perform in the same manner indicated above.

### EXAMPLE 5

### Application of Composition to Stainless Steel Sink

When applied to a stainless steel sink, the composition of the invention acts like a conventional soap. After application, the composition will start to break down into a liquid, with the result of dripping down the surface and eventually entering the drain. Wiping the sides of the sink afterwards also helps penetration and removal of organic matter. The composition of the invention will perform as described above once entering the drain, and thus, as it washes down the pipe, the liquid will start coating the surface of the pipes and the bacteria and IGR will start working in the same manner as described above in Example 3.

In addition, while in the examples above the fill weight of the aerosol can is about 567 grams, other sizes of cans and thus other fill weights could also be used with the composition of the invention and the calculations performed above could be used to determine the appropriate amount of bioremediation agent needed to obtain the desired CFU per can.

Furthermore, the composition of the invention can be applied to other surfaces that may be soiled by grease and organic waste materials and suitable contact times can be established by one skilled in the art.

While the invention has been described above with reference to specific embodiments thereof, it is apparent that many changes, modifications, and variations can be made without departing from the inventive concept disclosed here. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A foamable aqueous cleaning composition, the cleaning comprising:
a) about 40 to about 60 percent by weight water;
b) about 40 to about 60 percent by weight of a bioremediation agent capable of breaking down organic contaminating material and capable of producing a desired number of colony forming units of microbes;
c) optionally, an insect growth regulator; and
d) about 7 to about 15 percent by weight of a compatible propellant; and
wherein the water, the bioremediation agent and the insect growth regulator, if used, are charged to an empty can and the aerosol propellant that is compatible with the composition is added to the can.

2. The foamable composition according to claim 1, wherein composition comprises approximately equal amounts of water and the bioremediation agent.

3. The foamable composition according to claim 1, wherein the bioremediation agent comprises:
a) one or more surfactants;
b) one or more microbes that are capable of digesting organic contaminating material;
c) a preservative; and
d) a balance of water.

4. The foamable composition according to claim 3, wherein the microbes in the bioremediation agent are selected from the group consisting of strains of Bacillus, Pseudomonas, Arthrobacter, Enterobacter, Citrobacter and Corynebacter and combinations of one or more of the foregoing.

5. The foamable composition according to claim 3, wherein the microbes in the bioremediation agent are selected from the group consisting of Bacillus licheniformis, Pseudomonas florescens, Alcaligenes latus, Bacillus subtilis, Pseudomonas putida, and combinations of one or more of the foregoing.

6. The foamable composition according to claim 1, wherein the composition has a near neutral pH.

7. The foamable composition according to claim 1, wherein the composition has an expansion ratio of between about 25 to 1 and about 60 to 1.

8. The foamable composition according to claim 1, wherein the propellant comprises a mixture of isobutane and propane.

9. The foamable composition according to claim 1, wherein the composition comprises at least about 150 million colony forming units of microbes per can.

10. The foamable composition according to claim 9, wherein the composition comprises at least about 165 million colony forming units of microbes per can.

11. The foamable composition according to claim 1, wherein the composition comprises at least about 1.7 trillion colony forming units of microbes per can.

12. The foamable composition according to claim 1, wherein the composition contains an insect growth regulator selected from the group consisting of 2-[1-methyl-2(4-phenoxyphenoxy)ethoxy]pyridine, methoprene and hydroprene.

13. The foamable composition according to claim 12, wherein the insect growth regulator is 2-[1-methyl-2(4-phenoxyphenoxy)ethoxy]pyridine.

14. A method of treating surfaces to dissolve grease and organic waste materials thereon, wherein the method comprises the steps of:
a) providing a foamable aqueous cleaning composition changed to an aerosol can, the foamable cleaning composition comprising:
i) about 40 to about 60 percent by weight water;
ii) about 40 to about 60 percent by weight of a bioremediation agent capable of breaking down organic contaminating material and capable of producing a desired number of colony forming units;
iii) optionally, an insect growth regulator; and
iv) about 7 to about 15 percent by weight of a compatible propellant;
b) aerosolizing the foamable composition to release the foam composition through a nozzle in the aerosol can;
c) contacting the foam composition with the surfaces to be treated, and
d) allowing the foam composition to stand on the surfaces to be treated until the foam dissipates;
wherein grease and organic waste materials on the surfaces to be treated are dissolved and consumed.

15. The method according to claim 14, wherein the bioremediation agent comprises:
a) one or more surfactants;
b) one or more microbes that are capable of digesting organic contaminating material;
c) a preservative; and
d) a balance of water.

16. The method according to claim 15, wherein the microbes in the bioremediation agent are selected from the group consisting of strains of Bacillus, Pseudomonas, Arthrobacter, Enterobacter, Citrobacter and Corynebacter and combinations of one or more of the foregoing.

17. The method according to claim 15, wherein the microbes in the bioremediation agent are selected from the group consisting of Bacillus licheniformis, Pseudomonas florescens, Alcaligenes latus, Bacillus subtilis, Pseudomonas putida, and combinations of one or more of the foregoing.

18. The method according to claim 14, wherein the composition has an expansion ratio of between about 25 to 1 and about 60 to 1.

19. The method according to claim 14, wherein the propellant comprises a mixture of isobutane and propane.

20. The method according to claim 14, wherein the surfaces to be treated are selected from the group consisting of drains, baseboards, cracks, crevices and combinations of one or more of the foregoing.

21. The method according to claim 14, wherein the foam composition is allowed to stand on the surfaces to be treated for about 10 to 15 minutes.

22. The method according to claim 21, further comprising the step of rinsing or wiping any remaining foam product from the treated surface.

23. The method according to claim 14, comprising the step of shaking the foamable composition for a period of time to mix the composition prior to aerosolizing the foamable composition.

24. The method according to claim 14, wherein the foamable composition is prepared by charging the water and the bioremediation agent to the aerosol can and thereafter adding the compatible propellant.

25. The method according to claim 24, wherein the nozzle is a void injector tube that is attached to an actuator button on the aerosol can, whereby the product is dispensed from the void injector tube by depressing the actuator button.

26. The method according to claim 20, wherein the surface to be treated is a drain and the foamable composition is dispensed until the foamable composition reaches the surface of the drain.

27. The method according to claim 14, wherein the composition comprises at least about 150 million colony forming units of microbes per can.

28. The method according to claim 27, wherein the composition comprises at least about 165 million colony forming units of microbes per can.

29. The method according to claim 14, wherein the composition comprises at least about 1.7 trillion colony forming units of microbes per can.

30. The method according to claim 14, wherein the composition contains an insect growth regulator selected from the group consisting of 2-[1-methyl-2(4-phenoxyphenoxy)ethoxy]pyridine, methoprene and hydroprene.

31. The method according to claim 30, wherein the insect growth regulator is 2-[1-methyl-2(4-phenoxyphenoxy)ethoxy]pyridine.
